(19) United States
(12) Patent Application Publication
(10) Pub. No.: US 2009/0150361 A1
(43) Pub. Date: Jun. 11, 2009

(54) SUPPORTING CREATION OF SEARCH EXPRESSIONS EMPLOYING A PLURALITY OF WORDS

(75) Inventors: Koji Akiyama, Kanagawa-ken (JP); Yasuko Andoh, Tokyo (JP); Norihiko Izumi, Yokohama-shi (JP)

Correspondence Address: IBM CORPORATION;C/O: RADER, FISHMAN & GRAUER PLLC, 10653 S. RIVER FRONT PKWY., STE. 150, SOUTH JORDAN, UT, 84095, US

(73) Assignee: INTERNATIONAL BUSINESS MACHINES CORPORATION, Armonk, NY (US)

(21) Appl. No.: 12/333,261

(22) Filed: Dec. 11, 2008

(30) Foreign Application Priority Data
Dec. 11, 2007 (JP) 2007-320044

(51) Int. Cl. G06F 17/30

(52) U.S. Cl. 707/3; 707/7; 707/E17.014; 707/E17.017

(57) ABSTRACT

A method, apparatus, and computer program product for supporting creation of a search expression that employs a plurality of words may display a search expression creation support screen comprising a search word field for inputting therein search words and a search expression field for visually displaying, in a nodal form, a search expression that includes the inputted search words, sort the search words, inputted in the search word field, into one or more groups depending on their categories, display, in the search expression field, the search words included in each of the groups as OR-connected nodes, while displaying connections between the groups as AND-connections, and change a search expression in the search expression field in response to a user's operation that has been performed in the search word field or in the search expression field.

### BACKGROUND OF THE INVENTION

The present invention relates to an information search, and more particularly to a method, an apparatus, and a program for supporting creation of a search expression in the information search that employs a plurality of words as a key.

In order to perform a search with a plurality of words being employed as a key, a search program employs logical operators to combine search words. However, when a search condition is complicated, e.g., when a way of representing a logical expression to be inputted differs depending on the search program or when mathematical knowledge is required, a user is imposed a burden to represent the search condition using a correct logical expression. Therefore, various measures have been proposed to help the user to create a logical expression.

For example, in the information search using the Internet, when a plurality of search words are entered in a search word input field with the search words being delimited by space characters, and a search button is clicked on, search results consonant with the input search condition are displayed. Further, it has been put into practice that an input field for AND-connection, an input field for OR-connection, and an input field for NOT-connection are separately provided.

One method for automatically generating a search expression based on a plurality of input search words (keywords) is disclosed in Japanese Patent Application Publication No. 9-114841. According to this method, a keyword apparatus looks into a thesaurus to determine whether or not a plurality of keywords is synonymous with one another. When the keywords are synonymous with one another, these keywords are OR-connected to form a cluster and the cluster is AND-connected with another cluster, so as to prepare a search expression to be used for a search process.

Another method for supporting a user in preparing a search expression is disclosed in Japanese Patent Application Publication No. 11-45271. According to this method, a plurality of search condition icons that represent the respective search conditions, an AND icon used to designate an AND condition, an OR icon used to designate an OR condition, a NOT icon used to designate a negative condition and a DB icon used to designate a search target or to designate a search start, are displayed on a screen, and a search expression is set up by dragging-and-dropping one of the search condition icons on the AND icon, the OR icon and/or the NOT icon, and then, the AND icon, the OR icon or the NOT icon, where the search expression has been set up, is dragged-and-dropped on the DB icon to set up a search condition used for a search.

According to the information search using the Internet and the method disclosed in Japanese Patent Application Publication No. 9-114841, once a user enters search words, a search expression is prepared in accordance with a logic that is uniquely defined by a search site, and a search is performed based on the search expression. The advantage of this method is that a user needs only to enter search words, without having to take into account logical operators, such as AND and OR operators. Nevertheless, since the search expression is not displayed on the screen, the user can not ascertain whether or not a search is actually being performed as intended, and is also unable to know how to make a desirable search expression change. This is also true in the method disclosed in Japanese Patent Application Publication No. 11-45271.

### BRIEF SUMMARY OF THE INVENTION

According to one embodiment of the present invention, a method for supporting creation of a search expression that employs a plurality of words is disclosed, comprising the steps of displaying a search expression creation support screen comprising a search word field for inputting therein search words and a search expression field for visually displaying, in a nodal form, a search expression that includes the inputted search words, sorting the search words, inputted in the search word field, into one or more groups depending on their categories, displaying, in the search expression field, the search words included in each of the groups as OR-connected nodes, while displaying connections between the groups as AND-connections, and changing a search expression in the search expression field in response to a user's operation that has been performed in the search word field or in the search expression field.

According to another embodiment of the present invention, an apparatus for supporting creation of a search expression that employs a plurality of words is disclosed, comprising a display unit configured to display a search expression creation support screen comprising a search word field for inputting therein search words and a search expression field for visually displaying, in a nodal form, a search expression that includes the inputted search words, a categorization unit configured to sort the search words, inputted in the search word field, into one or more groups depending on their categories, and a search expression creation unit configured to display, in the search expression field, the search words included in each of the groups as OR-connected nodes, and display connections between the groups as AND-connections, wherein the search expression creation unit changes a search expression in the search expression field in response to a user's operation that has been performed in the search word field or in the search expression field.

According to another embodiment of the present invention, a changing a search expression in the search expression field in response to a user's operation that has been performed in the search word field or in the search expression field. computer program product for supporting creation of a search expression that employs a plurality of words is disclosed, the computer program product comprising a computer usable medium having computer usable program code embodied therewith, the computer usable program code comprising computer usable program code configured to display a search expression creation support screen comprising a search word field for inputting therein search words and a search expression field for visually displaying, in a nodal form, a search expression that includes the inputted search words, computer usable program code configured to sort the search words, inputted in the search word field, into one or more groups depending on their categories, computer usable program code configured to display, in the search expression field, the search words included in each of the groups as OR-connected nodes, while displaying connections between the groups as AND-connections, and computer usable program code configured to change a search expression in the search expression field in response to a user's operation that has been performed in the search word field or in the search expression field.

### BRIEF DESCRIPTION OF THE SEVERAL VIEWS OF THE DRAWINGS

FIG. 1 is a block diagram illustrating a functional configuration of a search expression creation support apparatus according to an embodiment of the present exemplary system and method.

FIG. 2 is a diagram illustrating a search expression creation support screen displayed on the display unit of the search expression support apparatus of FIG. 1, according to an embodiment of the present exemplary system and method.

FIG. 3 is a flowchart illustrating the operation of the search expression creation support apparatus of FIG. 1, according to an embodiment of the present exemplary system and method.

FIG. 4 is a flowchart illustrating a frequent word processing routine performed by the frequent word processing section of the search expression creation support apparatus of FIG. 1, according to an embodiment of the present exemplary system and method.

FIG. 5 is a diagrammatic view illustrating a state in which, using space delimiters, a user has entered a plurality of search words in the search word field of a search expression creation support screen according to an embodiment of the present exemplary system and method.

FIG. 6A is a diagrammatic view illustrating a search expression creation support screen that is displayed when the user presses a run button in the state illustrated in FIG. 5, according to an embodiment of the present exemplary system and method.

FIG. 6B is a diagrammatic view illustrating a template for creating a search expression to be displayed in a nodal form on the search expression creation support screen according to an embodiment of the present exemplary system and method.

FIG. 7 is a diagrammatic view illustrating a search expression creation support screen that is displayed when, in the state illustrated in FIG. 6A, the user presses the run button in order to perform a search according to an embodiment of the present exemplary system and method.

FIG. 8 is a diagrammatic view illustrating a state in which a specific frequent word, displayed in the frequent word field of the search expression creation support screen, is dragged-and-dropped in the search expression field and is AND-connected to the node of the end group according to an embodiment of the present exemplary system and method.

FIG. 9 is a diagrammatic view illustrating a state in which a specific frequent word, displayed in the frequent word field of the search expression creation support screen, is dragged-and-dropped into the search expression field and is OR-connected to the node of an existing group according to an embodiment of the present exemplary system and method.

FIG. 10 is a diagrammatic view illustrating a state in which a specific frequent word, displayed in the frequent word field of the search expression creation support screen, is dragged-and-dropped into the search expression field and is AND-connected to the node of the end group, and, thereafter, an exclusion button of the frequent word node is pressed according to an embodiment of the present exemplary system and method.

FIG. 11 is a diagrammatic view illustrating a state in which, in the search expression field of the search expression creation support screen, by performing a drag-and-drop operation a connector located between the two nodes of a specific group is changed from an OR connection of the two nodes to an OR connection between one of the two nodes and the rest of the nodes according to an embodiment of the present exemplary system and method.

FIG. 12 is a diagrammatic view illustrating a state in which, in the search expression field of the search expression creation support screen, by using a drag-and-drop operation, a connector located between the two nodes of a specific group is moved to a position between either node of the specific group and a node of another group according to an embodiment of the present exemplary system and method.

FIG. 13 is a diagrammatic view illustrating a state in which, in the search expression field of the search expression creation support screen, a node included in a specific group is copied to the same group according to an embodiment of the present exemplary system and method.

FIG. 14 is a diagrammatic view illustrating a state in which, in the search word field of the search expression creation support screen, a specific search word is changed to another search word according to an embodiment of the present exemplary system and method.

FIG. 15 is a block diagram illustrating an exemplary configuration of a data processing system that may be implemented as the search expression creation support apparatus according to an embodiment of the present exemplary system and method.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to the Internet, wireline, optical fiber cable, RF, etc.

Computer program code for carrying out operations of the present invention may be written in an object oriented programming language such as Java, Smalltalk, C++, or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

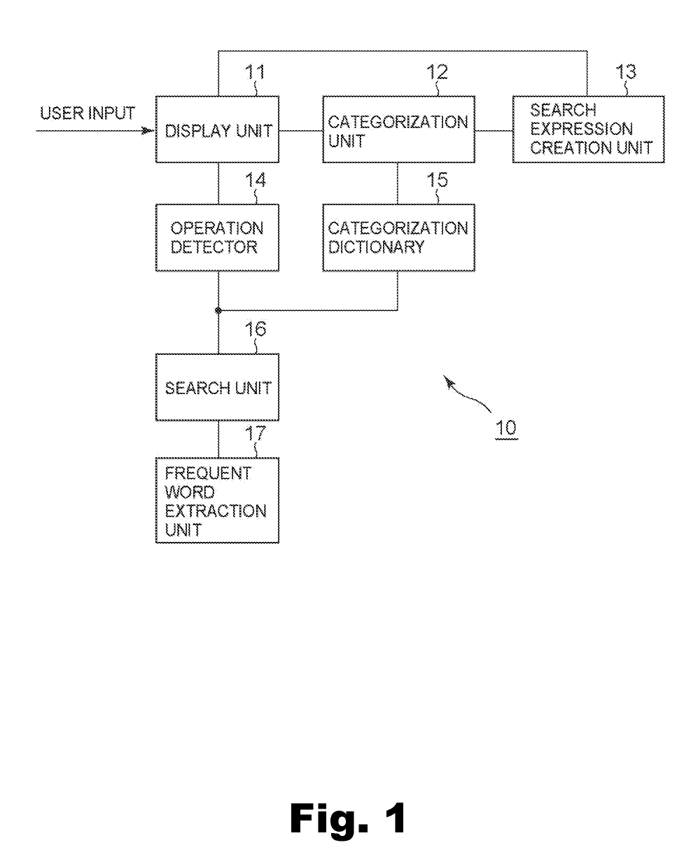

FIG. 1 illustrates an exemplary functional configuration of a search expression creation support apparatus according to an embodiment of the present exemplary system and method. With reference now to FIG. 1, a search expression creation support apparatus (10) includes a display unit (11), a categorization unit (12), a search expression creation unit (13), an operation detector (14), a categorization dictionary (15), a search unit (16), and a frequent word extraction unit (17). In order to visually present a search expression that has been prepared by the search expression creation unit (13) in response to an user's inputting operation, the display unit (11) displays a search expression creation support screen that includes a search word field for inputting search words and a search expression field for visually displaying, in a nodal form, a search expression that includes the inputted search words.

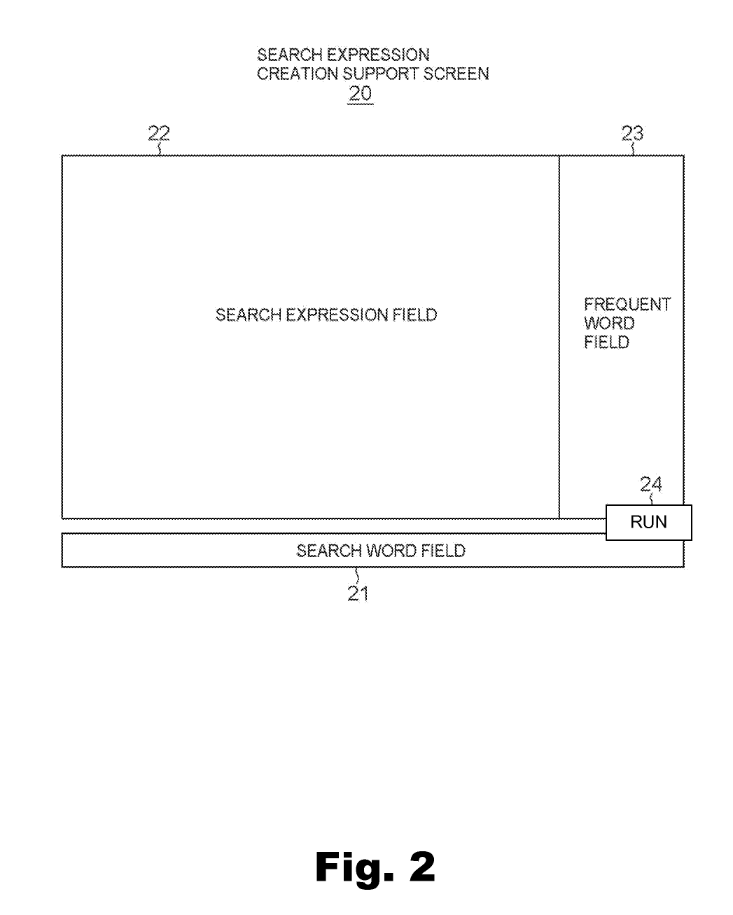

FIG. 2 illustrates a search expression creation support screen (20) displayed on the display unit (FIG. 1, 11). The search expression creation support screen (20) in FIG. 2 includes a search word field (21) in which a user inputs search words for a search, a search expression field (22) in which a search expression that includes the inputted search word or words is to be visually displayed in a nodal form, a frequent word field (23) for displaying a frequently appearing word or words (referred to as “frequent word” hereinafter) included in search results, and a run button (24). Details of the search expression creation support screen (20) will be described later.

Referring again to FIG. 1, the categorization unit (12) employs the categorization dictionary (15) to sort search words inputted in the search word field (FIG. 2, 21) into one or more groups depending on the categories of the words. The search expression creation unit (13) then creates a search expression to be visually displayed in a nodal form in the search expression field (FIG. 2, 22) of the search expression creation support screen (FIG. 2, 20). Search words that are included in each group are displayed as OR-connected nodes, and connections between the groups of words are displayed as AND-connections. Further, when a user operation is performed in the search word field (FIG. 2, 21) or in the search expression field (FIG. 2, 22), the search expression creation unit (13) changes the search expression in the search expression field (FIG. 2, 22). The operation detector (14) detects an operation (e.g., pressing of the run button (FIG. 2, 24)) performed by the user on the search expression creation support screen (FIG. 2, 20) of the display unit (11), and causes the categorization unit (12), the search expression creation unit (13), the search unit (16) or the frequent word extraction unit (17) to initiate a corresponding process. In the categorization dictionary (15), multiple words that qualify as search word candidates are stored in association with their categories, and in response to an inquiry received from the categorization unit (12) using the search words, categories associated with the search words are outputted to the categorization unit (12). Then, when the run button (FIG. 2, 24) is pressed in a state wherein a search expression is displayed in the search expression field (FIG. 2, 22), the search unit (16) performs a search operation. And, based on the search results performed by the search unit (16), the frequent word extraction unit (17) extracts frequent words and displays them in the frequent word field (FIG. 2, 23) of the search expression creation support screen (20).

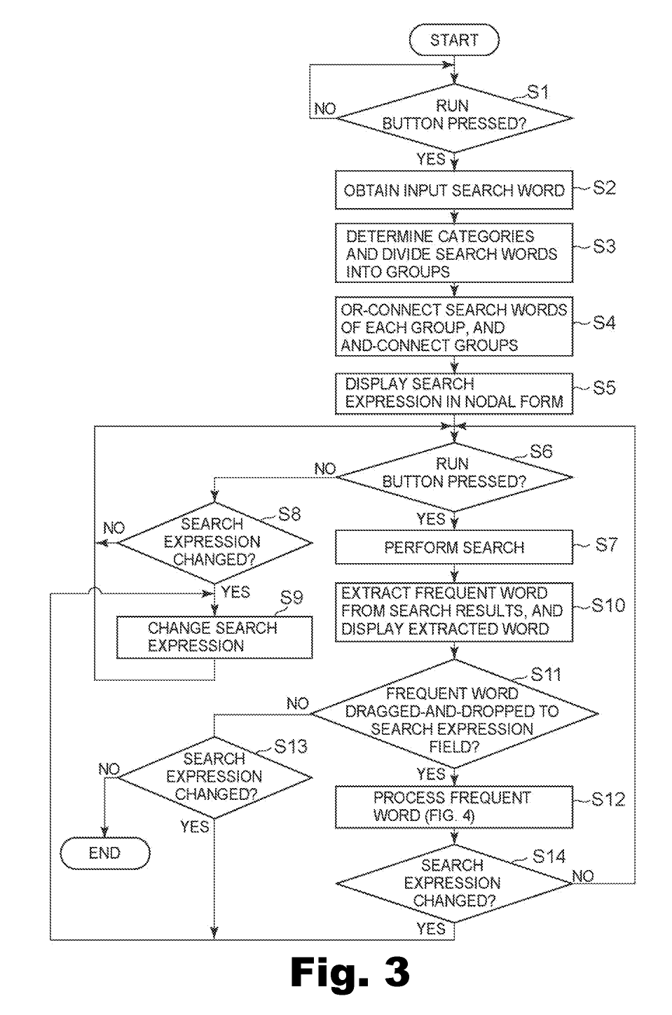

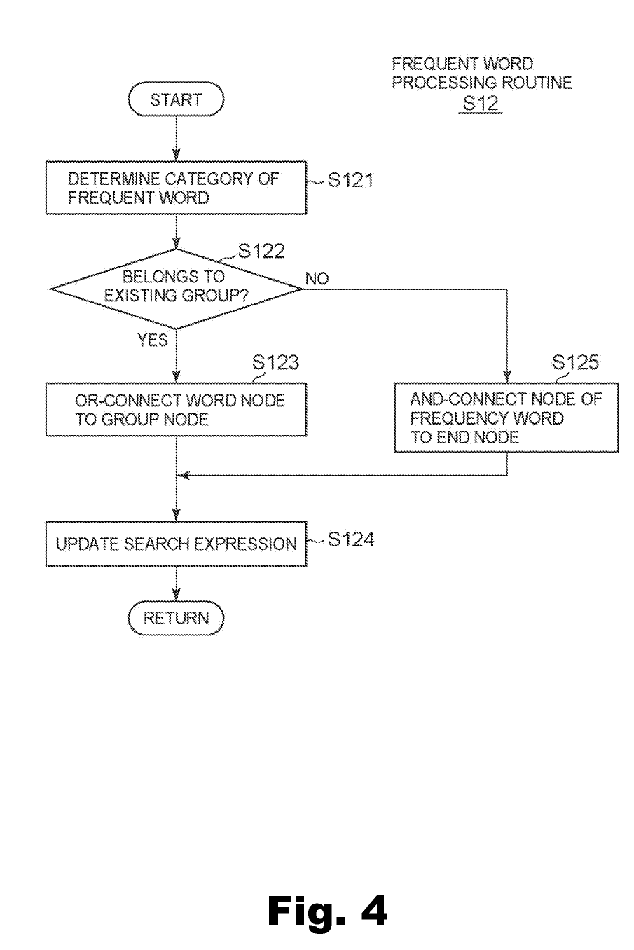

The operation of the search expression creation support apparatus (10) of FIG. 1 will now be described with reference to FIGS. 3 and 4. FIG. 3 is a flowchart illustrating the operation of the search expression creation support apparatus (FIG. 1, 10), according to an embodiment of the present exemplary system and method. FIG. 4 is a flowchart illustrating a frequent word processing routine performed by the frequent word processing section of the search expression creation support apparatus (FIG. 1, 10), according to an embodiment of the present exemplary system and method. At step S1, the operation detector (FIG. 1, 14) determines whether the run button (FIG. 2, 24) is pressed in a state wherein search words have been inputted in the search word field (FIG. 2, 21). If the run button (FIG. 2, 24) is not pressed, the operation detector (FIG. 1, 14) waits until the run button (FIG. 2, 24) is pressed. When the run button (FIG. 2, 24) is pressed, program control advances to step S2 and the categorization unit (FIG. 1, 12) obtains the inputted search words. If no search word has been inputted in the search word field (FIG. 2, 21) when the run button (FIG. 2, 24) is pressed, a warning message, such as “Please input search words,” may be displayed on the search expression creation support screen (FIG. 2, 20). The operation detector (FIG. 1, 14) may detect the pressing of the run button (FIG. 2, 24) when clicking is done in a state wherein a cursor (not shown) is positioned on the run button (FIG. 2, 24), or when a keyboard “Enter” key is pressed.

At step S3, the categorization unit (FIG. 1, 12) determines a category of each search word by inquiring the categorization dictionary (FIG. 1, 15) with the obtained search words, and sorts the search words into one or more groups, in accordance with their determined categories. Thereafter, the categorization unit (FIG. 1, 12) transmits the categorization results to the search expression creation unit (FIG. 1, 13). Then, at step S4, the search expression creation unit (FIG. 1, 13) OR-connects search words included in the same groups and AND-connects the groups based on the results obtained from the categorization unit (FIG. 1, 12), and, at step S5, displays the search expression thus obtained on the display unit (FIG. 1, 11) in a nodal form.

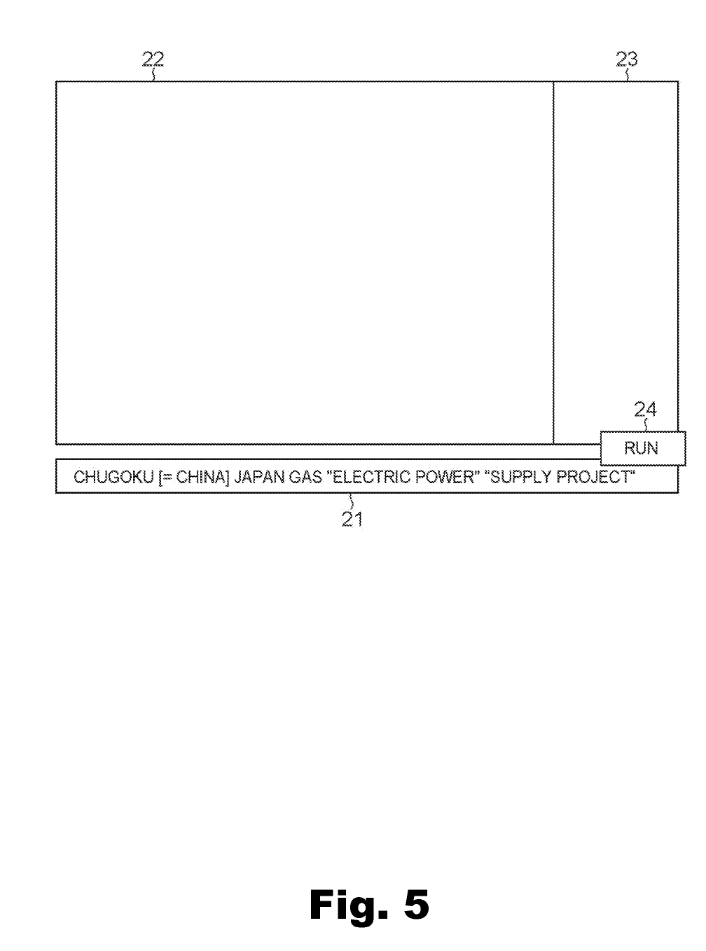

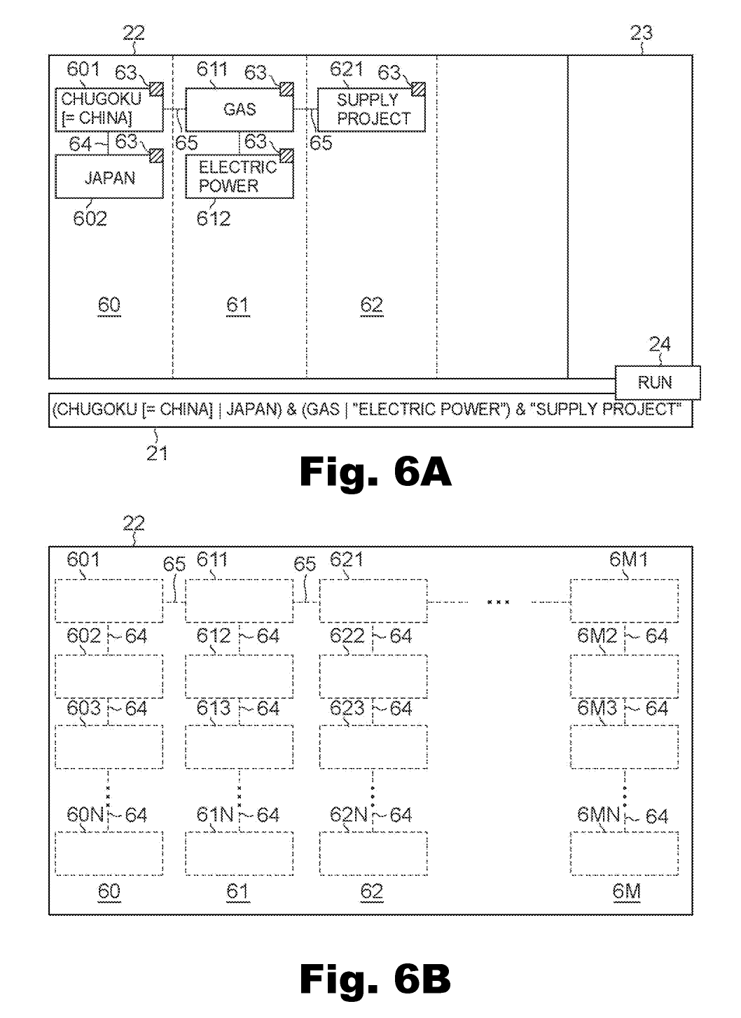

FIGS. 5, 6A, and 6B illustrate an example of the above process. Specifically, FIG. 5 is a diagrammatic view illustrating a state in which, using space delimiters, a user has entered a plurality of search words in the search word field of a search expression creation support screen according to an embodiment of the present exemplary system and method. FIG. 6A is a diagrammatic view illustrating a search expression creation support screen that is displayed when the user presses a run button in the state illustrated in FIG. 5, according to an embodiment of the present exemplary system and method. Finally, FIG. 6B is a diagrammatic view illustrating a template for creating a search expression to be displayed in a nodal form on the search expression creation support screen according to an embodiment of the present exemplary system and method.

To begin, FIG. 5 is an example wherein, to perform a search for “gas and electric power supply project in Chugoku (=People's Republic of China) and Japan,” a user may sequentially input the search words “Chugoku,” “Japan,” “gas,” “electric power” and “supply project” using space delimiters into the search word field (21). Then, when the run button (24) is pressed, steps S2 through S5 of FIG. 3 are performed, and the screen may then display the elements as depicted in FIG. 6A.

Specifically, after the run button (24) is pressed, the categorization unit (FIG. 1, 12) obtains the search words inputted in the search word field (21), i.e., “Chugoku,” “Japan,” “gas,” “electric power,” and “supply project” (step S2), and determines a category of each search word by inquiring the categorization dictionary (FIG. 1, 15) regarding the search words (FIG. 3, step S3). In this example, the categorization dictionary (FIG. 1, 15) may sort the words “Chugoku” and “Japan” into a “country name” category. Further, the categorization dictionary (FIG. 1, 15) may sort the words “gas” and “electric power” into an “energy” category. Finally, the categorization dictionary (FIG. 1, 15) may sort the words “supply project” into a general or default category denoted as “no category.” In one exemplary embodiment, the designation of “no category,” may also be applied to search words that are not registered in the categorization dictionary (FIG. 1, 15). After receiving the inquiry results from the categorization dictionary (FIG. 1, 15), the categorization unit (FIG. 1, 12) sorts “Chugoku” and “Japan” to a first group, sorts “gas” and “electric power” to a second group, and sorts “supply project” to a third group. Then, the categorization unit (FIG. 1, 12) transmits the categorization results to the search expression creation unit (FIG. 1, 13). At this time, the categorization results include the category names of the respective groups and the search words that are included in the groups identified by the category names.

Based on the categorization results received from the categorization unit (FIG. 1, 12), the search expression creation unit (FIG. 1, 13) OR-connects “Chugoku” and “Japan,” in the first group, OR-connects “gas” and “electric power” in the second group, and AND-connects the first, second and third groups (FIG. 3, step S4). The obtained results may be represented by a logical expression “(Chugoku|Japan) & (gas|electric power) & supply project.” The symbol “|” in the logical expression represents “OR,” and “&” represents “AND.” The search expression creation unit (FIG. 1, 13) may then display, in the search expression field (22) of the display unit (FIG. 1, 11), this logical expression as a search expression in a nodal form (FIG. 3, step S5) as depicted in FIG. 6A. Also, a corresponding logical expression may be concurrently displayed in the search word field (21). This logical expression may also be a type of search expression. However, in order to distinguish a logical expression displayed in the nodal form from a normal logical expression that uses logical operators such as OR and AND operators, the former logical expression may be referred to as a search expression in the following description.

A search expression displayed in the search expression field (22) of FIG. 6A may include a first node (601) for the search word “Chugoku.” a second node (602) for the search word “Japan,” a third node (611) for the search word “gas,” a fourth node (612) for the search word “electric power,” and a fifth node (621) for the search word “supply project.” The first node (601) and second node (602) form a first group (60). Similarly, the third node (611) and fourth node (612) form a second group (61), and the fifth node (621) forms a third group (62). In the first group (60) and the second group (61), OR-connection may be indicated by a vertical connector (64) positioned between the nodes. Further, in the example shown in FIG. 6A, AND-connection of the groups may be indicated by a horizontal connector (65) positioned between the topmost nodes of the respective groups. An exclusion button (63), which will be described later, may be displayed at the upper right corner of each node.

The search expression creation unit (FIG. 1, 13) may employ a template as depicted in FIG. 6B to create a search expression in a nodal form. In the template shown in FIG. 6B, multiple blank nodes (601 to 60N), (611 to 61N), (621 to 62N), . . . and (6M1 to 6MN) may be vertically arranged for the respective groups, the nodes in each group may be connected by vertical connectors (64) denoting OR-connections, and the topmost nodes (601, 611, 621, . . . and 6M1) of the respective groups are connected by the AND-connection connectors (65). All of the connectors (64 and 65) are initially in the disabled state. The search expression creation unit (13) creates a search expression by sequentially inputting search words in the nodes, beginning at the upper left node (601) of the template. In the example in FIG. 6A, based on the categorization results received from the categorization unit (12), the search expression creation unit (13) inputs the search words “Chugoku” and “Japan,” included in the first group (60), in the nodes (601 and 602), respectively, and enables the OR-connection vertical connector (64) between the nodes (601 and 602). Similarly, for the next group (61), the search expression creation unit (13) inputs the search words “gas” and “electric power” in the node (611) and node (612), respectively, and enables the OR-connection vertical connector (64) between the nodes (611 and 612). At this time, the search expression creation unit (13) also enables the AND-connection horizontal connector (65) between the topmost nodes (601 and 611) of the groups (60 and 61). Finally, the search expression creation unit (13) inputs, in the node (621), the search word “supply project,” which is included in the third group (62), and enables the AND-connection horizontal connector (65) between the nodes (611 and 621). Thereafter, the search expression creation unit (13) displays, on the display unit (11), the search expression in a nodal form obtained through this process. The display unit (11) displays only the nodes in which the search words have been inputted and the enabled connectors. It should be noted that, in the template in FIG. 6B, the number of nodes M arranged laterally and the number of nodes N arranged vertically may be appropriately determined. For example, M=N=10 may be employed.

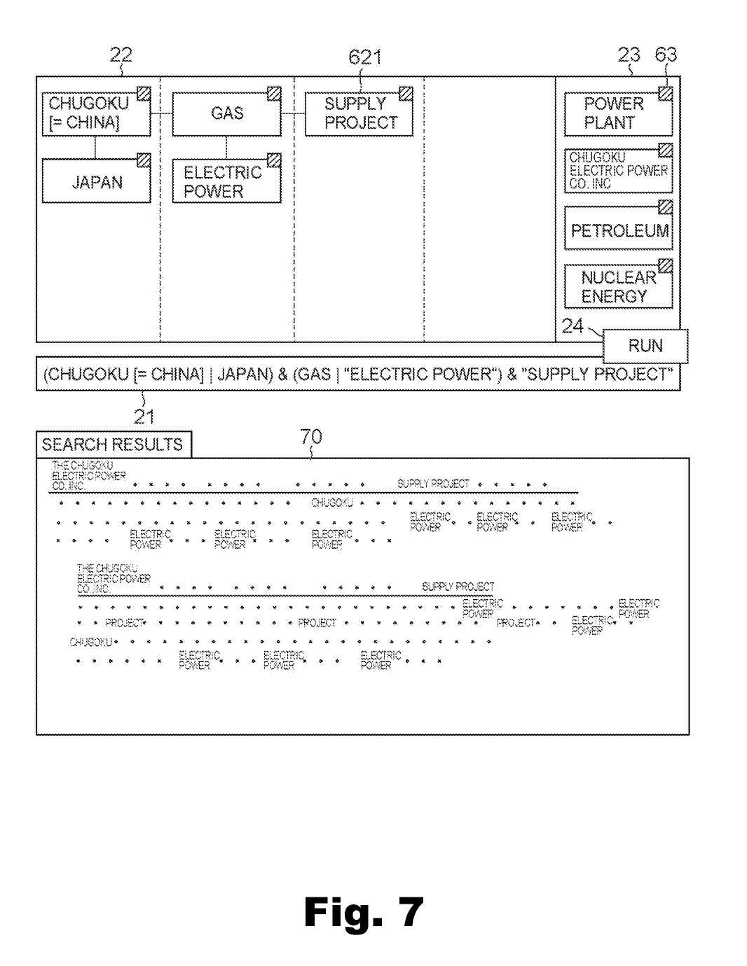

Referring again to FIG. 3, at step S6, the operation detector (14) determines whether the run button (24) is pressed while the search expression is displayed in the search expression field (22). If the run button (24) is pressed, program control advances to step S7 and the search unit (16) initiates a search. Also at step S7, the frequent word extraction unit (17) extracts frequent words from the search results and displays these words on the display unit (11). FIG. 7 illustrates an example of execution results obtained at steps S7 and S8.

FIG. 7 illustrates a screen that appears when the run button (24) is pressed in the state of FIG. 6. The search results are shown in a search results field (70), and are also transmitted from the search unit (16) to the frequent word extraction unit (17), which extracts frequent words from the received search results, selects a predetermined number of frequent words from the extracted frequent words in a descending order, beginning at the word having the highest frequency, and displays the extracted words in the frequent word field (23). In the example in FIG. 7, blocks of four frequent words “power plant,” “Chugoku Electric Power Co., Inc,” “petroleum,” and “nuclear energy” are displayed in the frequent word field (23). These frequent word blocks can be dragged-and-dropped.

Referring again to FIG. 3, at step S11, the operation detector (14) determines whether a specific frequent word displayed in the frequent word field (23) has been dragged-and-dropped in the search expression field (22). The drag-and-drop operation may be performed to narrow down the search results using a specific frequent word (adding an AND condition) or to add a search word to a specific group (adding an OR condition). When a specific frequent word is dragged-and-dropped in the search expression field (22), program control advances to step S12, and the frequent word processing routine illustrated in FIG. 4 is carried out.

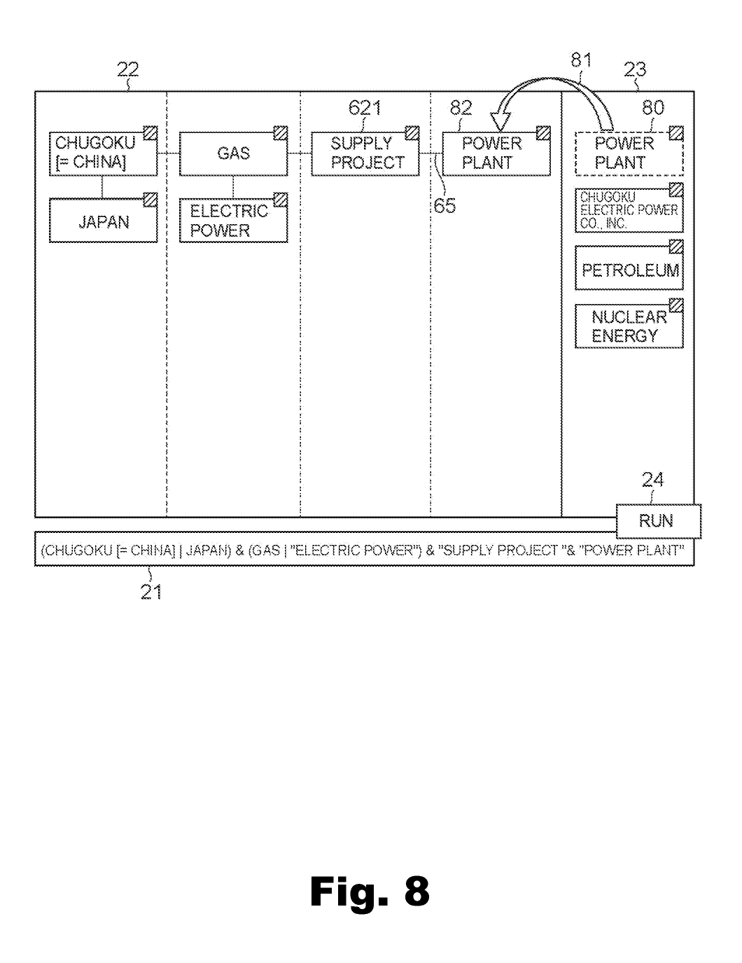

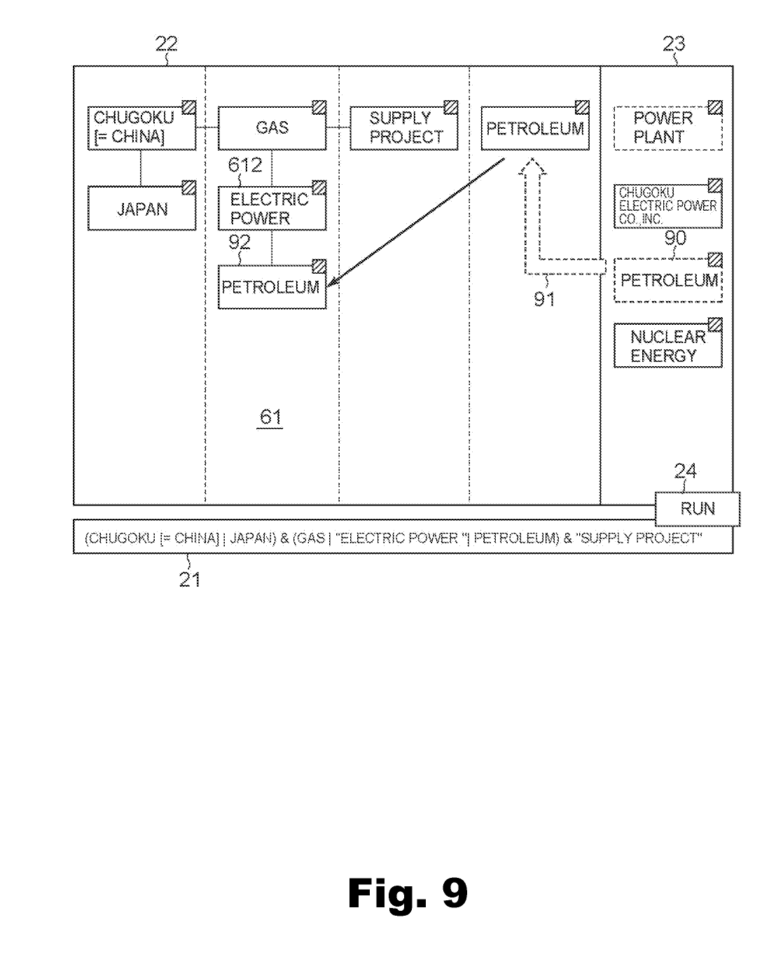

In the frequent word processing routine in FIG. 4, at the first step S121, a category of the frequent word that was dragged-and-dropped is determined. To this end, the operation detector (14) notifies the categorization unit (12) what frequent word was dragged-and-dropped in the search expression field (22). In response to the notification, the categorization unit (12) determines a category of this frequent word in the same manner as step S3, and transmits the results to the search expression creation unit (13). At step S122, the search expression creation unit (13) determines whether or not the dragged-and-dropped frequent word belongs to an existing group (in the example in FIG. 6, the group (60, 61 or 62)). If the frequent word belongs to one of these groups, program control advances to step S 123, and the node of the frequent word is OR-connected with the node of this group. Thereafter, at step S124, the search expression is updated. If the decision at step S122 is NO, program control advances to step S125 and the node of the frequent word is AND-connected with the node of the end group, and at step S124, the search expression is updated. FIGS. 8 and 9 illustrate examples of this frequent word processing.

In the example in FIG. 8, a block (80) for the frequent word “power plant” may be dropped in the search expression field (22) by a drag-and-drop operation (81). Assuming here that “power plant” is categorized as a building, “power plant” does not belong to any group, and thus, program control branches from S122 to S125, whereat a new “power plant” node (82) is AND-connected by the horizontal connector (65) with the end node, i.e., “supply project” node (621) of the end group (62), and thereafter, the search expression is updated. At this time, the logical expression in the search word field (21) is changed to “(Chugoku|Japan) & (gas|electric power) & supply project & power plant).” In this example, the search results are narrowed down by adding a new search word. Referring to the example in FIG. 8, after the “power plant” node (82) is additionally inputted, the search expression field (22) is full, and no other groups may be added. However, it is possible to provide a horizontal scroll bar at the bottom end of the search expression field (22) to enable the addition of a new group by horizontally scrolling the search expression field (22). Further, when a vertical scroll bar is provided at the right end of the search expression field (22), a greater number of nodes to be OR-connected for a specific group can be accommodated. The scroll bar may be preset to display all the nodes of the template shown in FIG. 6B, or may be set when a new node is to be added to the search expression field (22) that has become full.

In the example in FIG. 9, a block (90) of the frequent word “petroleum” is dropped in the search expression field (22) by a drag-and-drop operation (91). Assuming here that “petroleum” is categorized as energy, “petroleum” belongs to the second group (61), and therefore, program control advances from step S122 to S123, at which a new “petroleum” node (92) is OR-connected with the “electric power” node (612) by the vertical connector (64). Then, the search expression is updated. At this time, the logical expression in the search word field (21) is updated to “(Chugoku|Japan) & (gas|electric power|petroleum) & supply project.”

According to the frequent word processing routine in FIG. 4, a category is determined for each of the frequent words that are dragged-and-dropped. However, in a case where a block of a frequent word is dropped in the end node, the frequent word may be unconditionally AND-connected with the end node. For example, in FIG. 8, when the “power plant” block (80) is dropped in the “supply project” node (82), step S125 may be immediately executed.

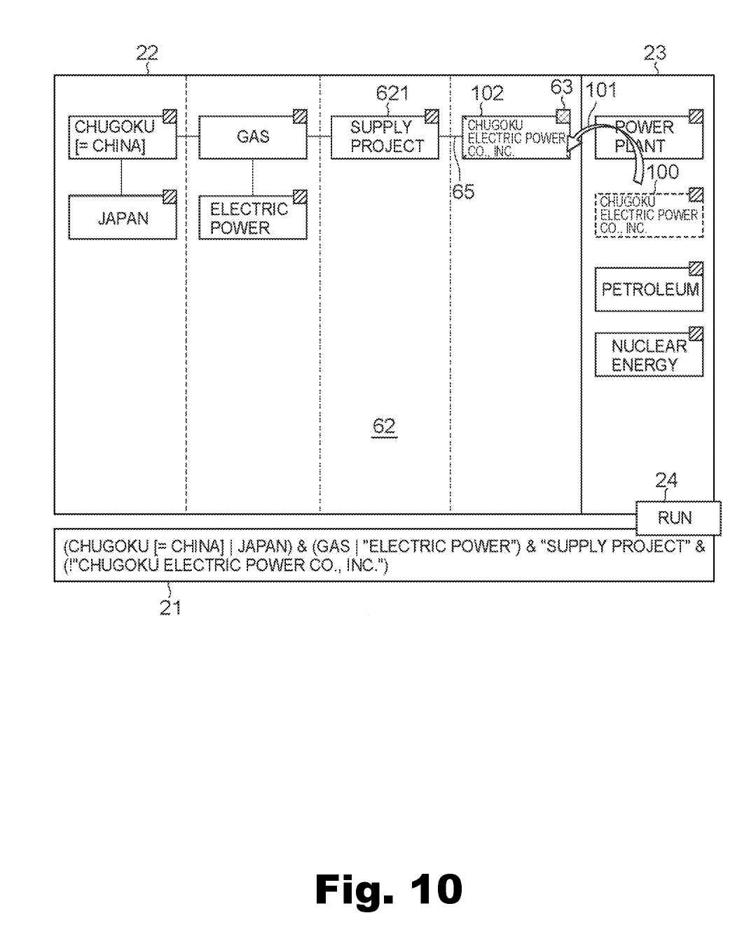

Referring again to FIG. 3, when the frequent word processing routine at step S12 has ended, the operation detector (14) determines, at step S14, whether or not the search expression has been changed by a user operation, other than the drag-and-drop operation used for the frequent words. When a user operation is detected at step S14, program control advances to step S9, and the search expression creation unit (13) changes the search expression. Either when the changing of the search expression is completed, or when no user operation is detected at step S14, program control returns to step S6. FIGS. 10 to 14 illustrate an example process for changing the search expression by means of a user operation.

FIG. 10 illustrates an example of narrowing down the search results by removing, from the search condition “gas and electric power supply project in Chugoku (=People's Republic of China) and Japan,” a word which does not fit a search that the user intends. In this example, a block 100 of the frequent word “Chugoku Electric Power Co., Inc” is dropped in the search expression field (22) by a drag-and-drop operation (101). Assuming here that “Chugoku Electric Power Co., Inc” is categorized as a company name, a new “Chugoku Electric Power Co, Inc” node (102) is AND-connected by the horizontal connector (65) to the “supply project” (621) of the end group (62) in the same manner as described in the example in FIG. 8. Then, the search expression is updated. At this time, the logical expression in the search word field (21) is also updated to “(Chugoku|Japan) & (gas|electric power) & supply project & Chugoku Electric Power Co., Inc.” This operation corresponds to the frequent word processing routine in FIG. 4. Then, when the user presses the exclusion button (63) of the “Chugoku Electric Power Co., Inc” node (102), the operation detector (14) detects this and notifies the search expression creation unit (13) that the exclusion button (63) of the “Chugoku Electric Power Co., Inc.” node (102) has been pressed. In response to the notification, the search expression creation unit (13) grays out the “Chugoku Electric Power Co., Inc” node (102) in the search expression field (22), so as to indicate that this node is excluded, and also changes the logical expression in the search word field (21) to “(Chugoku|Japan) & (gas|electric power) & supply project & (!Chugoku Electric Power Co., Inc.).” Here, the symbol “!” represents a NOT operator. When the user presses the run button (24) in this state, the user obtains search results such that “Chugoku Electric Power Co., Inc.” is excluded from the search results in FIG. 7. The same process is performed when the exclusion button (63) of a different node is pressed.

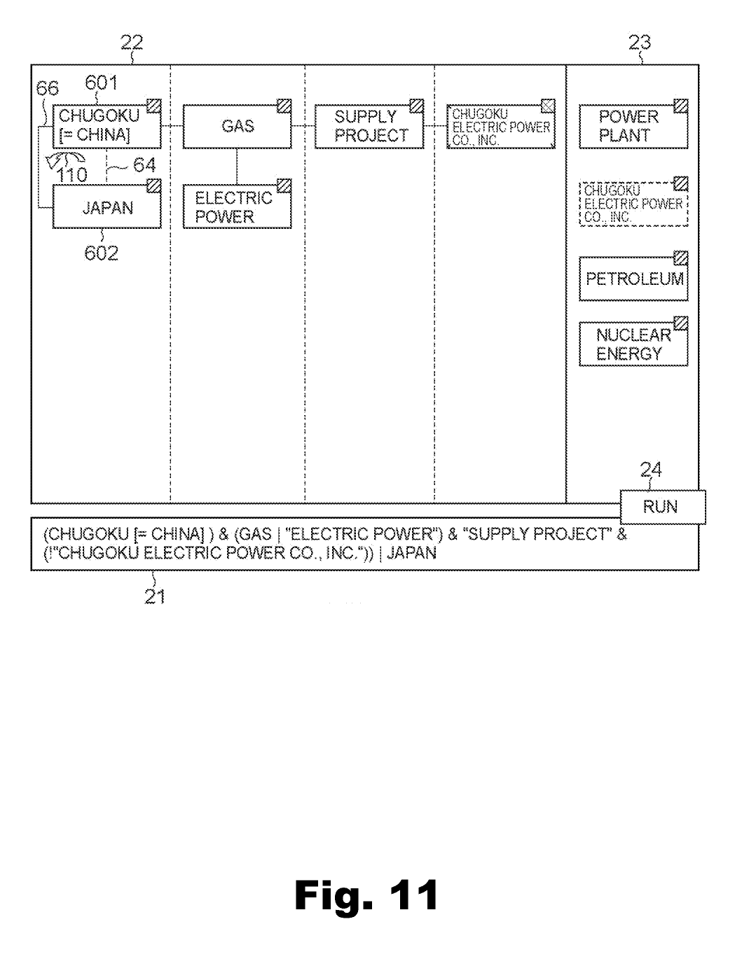

FIGS. 11 to 13 illustrate an example in which the user changes the search expression in FIG. 10 in order to perform a search for “supply project” of “gas” in “Chugoku” excluding “Chugoku Electric Power Co., Inc” or for “supply project” of “electric power” in “Japan.” First, in order to cancel the OR-connection between “Chugoku” and “Japan,” the user performs a drag-and-drop operation (110) as shown in FIG. 11 to drop the vertical connector (64), which OR-connects the “Chugoku” node (601) and the “Japan” node (602), outside these nodes (601 and 602) (to the left in FIG. 11). The operation detector (14) detects the drag-and-drop operation (110), and transmits the detection results to the search expression creation unit (13). Then, the search expression creation unit (13) deletes or disables the vertical connector (64) between the “Chugoku” node (601) and the “Japan” node (602), and OR-connects the “Japan” node (602) to the rest of the nodes. A connector (66) indicates this OR-connection. Further, the search expression creation unit (13) changes the logical expression in the search word field (21) to “(Chugoku & (gas|electric power) & supply project & (!Chugoku Electric Co., Inc.))|Japan.”

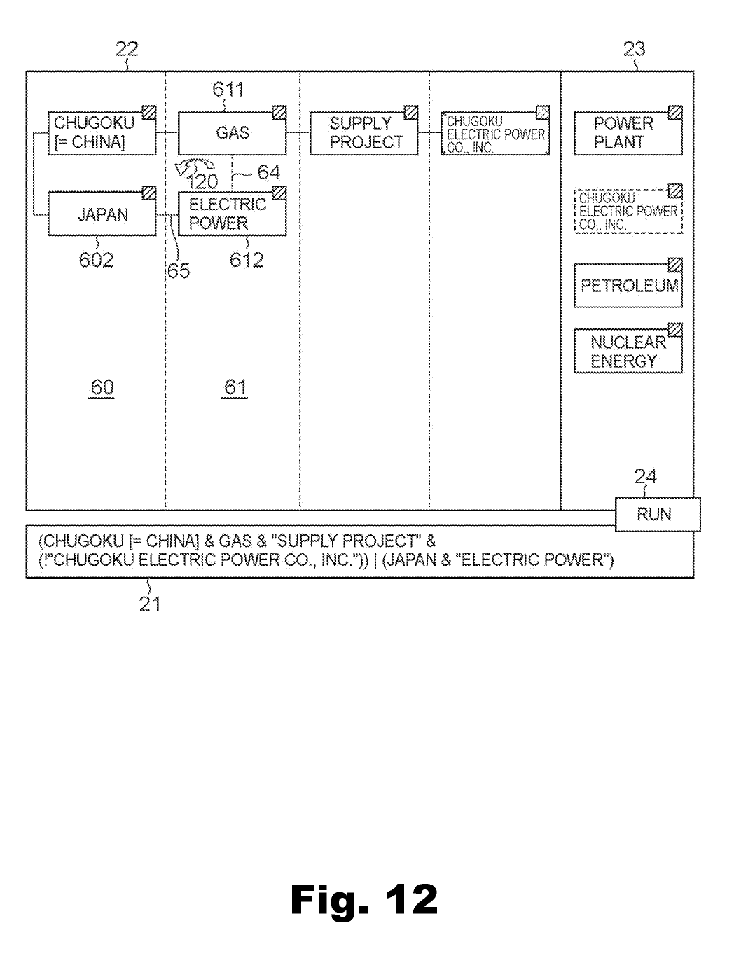

Next, as shown in FIG. 12, the user performs a drag-and-drop operation (120) to move the vertical connector (64), located between the “gas” node (611) and the “electric power” node (612), to a position between the “Japan” node (602) and the “electric power” node (612). The operation detector (14) detects the drag-and-drop operation (120), and notifies the search expression creation unit (13) of the detected operation. Then, the search expression creation unit (13) deletes the vertical connector (64) between the “gas” node (611) and the “electric power” node (612), and sets a new horizontal connector (65) between the “Japan” node (602) and the “electric power” node (612). Since the horizontal connector (65) is positioned between the groups (60 and 61), this represents an AND-connection. Therefore, the logical expression in the search word field (21) becomes “(Chugoku & gas & supply project & (!Chugoku Electric Power Co., Inc.))|(Japan & electric power).”

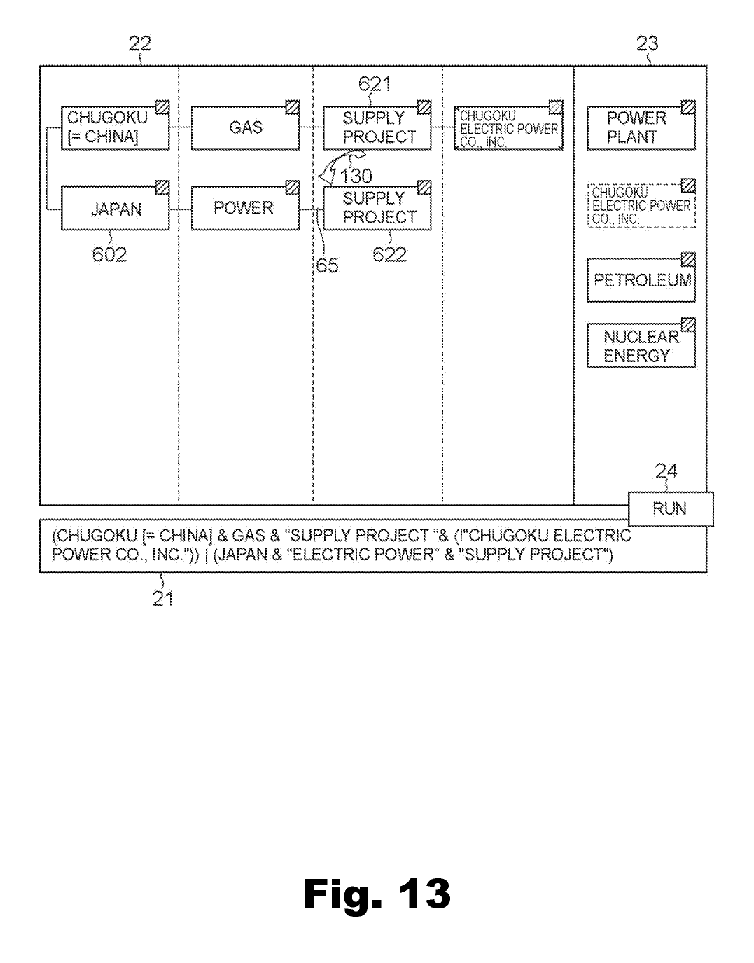

Finally, as shown in FIG. 13, in order to search for “supply project” of “electric power” in “Japan,” the user performs a copy operation (130) to copy the “supply project” node (621) to the right of the “electric power” node (612). The operation detector (14) detects this copy operation (130), and notifies the search expression creation unit (13) of the detected operation. In response to the notification, the search expression creation unit (13) AND-connects the “supply project” node (622) to the right of the “electric power” node (612) using the horizontal connector (65), and updates the logical expression in the search word field (21) to “(Chugoku & gas & supply project & (!Chugoku Electric Power Co., Inc.))|(Japan & electric power & supply project).” When the user presses the run button (24) in this state, a search is initiated based on the logical expression in the search word field (21).

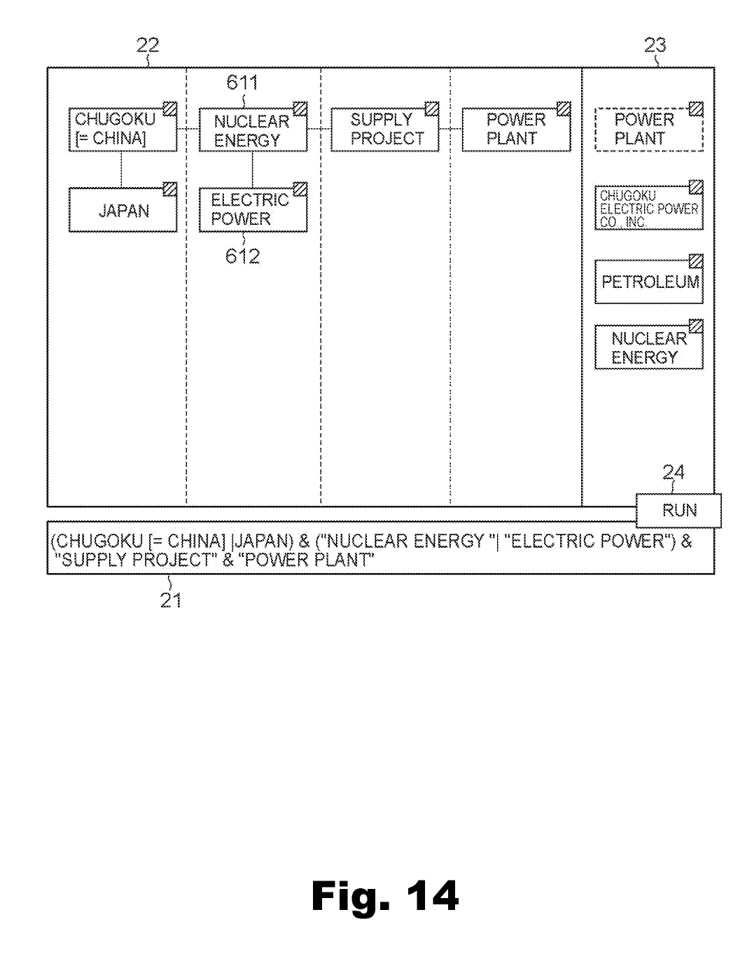

FIG. 14 illustrates an example in which the user edits the logical expression in the search word field (21) to change the search expression in the search expression field (22). In this example, the user changes the search word “gas” in the search word field (21) in FIG. 8 to “nuclear energy” so that the logical expression becomes “(Chugoku|Japan) & (nuclear energy|electric power) & supply project & power plant.” The operation detector (14) detects this change, and notifies the search expression creation unit (13) of the detected change. In response to the notification, the search expression creation unit (13) reflects the user's operation to change the logical expression on the search expression by changing the search word in the node (611) from “gas” to “nuclear energy.”

Referring back to FIG. 3, if the run button (24) is not pressed at step S6, program control advances to step S8 to determine whether or not the search expression has been changed. The operation at step S8 is the same as the one at step S14. If the search expression has been changed, program control advances to step S9 and the search expression change operation, as described above, is performed. If the search expression has not been changed, program control returns to step S6.

Further, if at step S11 a specific frequent word is not dragged-and-dropped in the search expression field (22), program control advances to step S13. The operation at step S13 is the same as the one at steps S8 and S14. If the search expression has been changed, program control advances to step S9 and the search expression change process described above is performed. Otherwise, the processing in FIG. 3 is terminated.

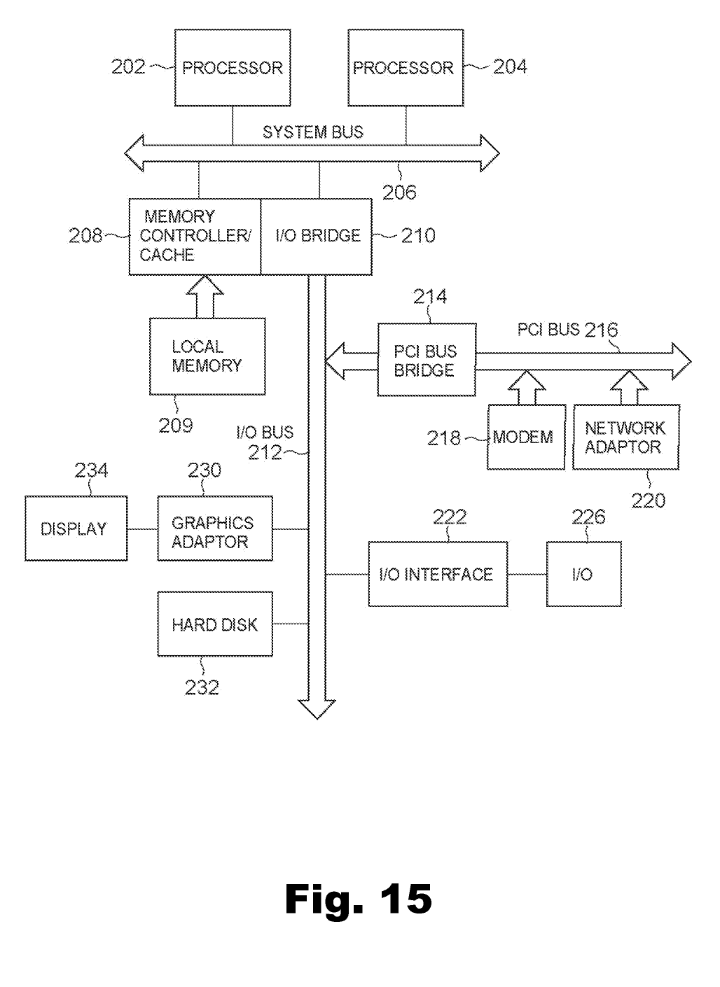

FIG. 15 illustrates an exemplary configuration of a data processing system that may be implemented as the search expression creation support apparatus (10) in FIG. 1. A data processing system (200) may be a symmetrical multiprocessor (SMP) system that includes a plurality of processors (202 and 204) connected to a system bus (206), or may be a single processor system. The processors (202 and 204) implement the functions of the categorization unit (12), the search expression creation unit (13), the operation detector (14), the search unit (16), and the frequent word extraction unit (17) of the search expression creation support apparatus (10). A memory controller/cache (208) may also be connected to the system bus (206), and provides an interface for a local memory (209). Furthermore, an I/O bus bridge (210) is connected to the system bus (206) and provides an interface for an I/O bus (212). The memory controller/cache (208) and the I/O bus bridge (210) may be employed as a single unit, as shown in FIG. 15.

A peripheral component interconnect (PCI) bus bridge (214), connected to the I/O bus (212), provides an interface for a PCI local bus (216). Several modems may be connected to the PCI local bus (216). For typical PCI bus implementation, four PCI extension slots or extension connectors are included. A communication link for network computers may be provided through a modem (218) and a network adaptor (220) that are connected to the PCI local bus (216) through an extension board.

I/O devices, such as a keyboard and a mouse, may be connected to the I/O bus (212) through an I/O interface (222). A memory mapped graphics adaptor (230) and a hard disk (232) may also be connected to the I/O local bus (212), directly or indirectly, as shown in FIG. 15. The categorization dictionary (15) is stored on the hard disk (232), and a display device (234) is connected to the graphics adaptor (230). The graphics adaptor (230) and the display device (234) serve as the display unit (11).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for supporting creation of a search expression that employs a plurality of words, comprising the steps of:
displaying a search expression creation support screen comprising a search word field for inputting therein search words and a search expression field for visually displaying, in a nodal form, a search expression that includes the inputted search words;
sorting the search words, inputted in the search word field, into one or more groups depending on their categories;
displaying, in the search expression field, the search words included in each of the groups as OR-connected nodes, while displaying connections between the groups as AND-connections; and
changing a search expression in the search expression field in response to a user's operation that has been performed in the search word field or in the search expression field.

2. The method according to claim 1, wherein each of the OR-connections and the AND-connections are expressed by an intemodal connector.

3. The method according to claim 2, wherein the step of changing the search expression changes the search expression in response to a user's operation on a connector in the search expression field.

4. The method according to claim 3, wherein the step of changing the search expression cancels, in response to the operation by which the connector has been moved in the search expression field, a connection relationship prior to the movement of the connector and establishes a new connection relationship after the movement.

5. The method according claim 1, further comprising the steps of:
extracting frequent words from the search results; and
displaying the extracted frequent words in a different field on the search expression creation support screen.

6. The method according to claim 5, further comprising the steps of:
determining, in response to a user's operation by which a specific frequent word displayed in the different field has been dragged-and-dropped in the search expression field, whether or not the specific frequent word is included in an existing group;
OR-connecting a node of the specific frequent word to a node of the existing group when the specific frequent word is included in the existing group; and
AND-connecting a node of the specific frequent word to the existing group when the specific frequent word is not included in the existing group.

7. The method according to claim 6, wherein the step of AND-connecting the node of the specific frequent word to the existing group comprises AND-connecting the node of the specific frequent word to a node of an end group among those groups that are AND-connected in the search field.

8. The method according to claim 5, further comprising a step of AND-connecting, in response to a user's operation by which a specific frequent word displayed in the different field has been dragged-and-dropped to a specific search word node in the search expression field, the specific frequent word to the specific search word node.

9. The method according to claim 1, further comprising the steps of:
adding an exclusion button to a number of individual search word nodes displayed in the search expression field; and
changing, in response to pressing of the exclusion button of a specific search word node, a connection of a corresponding search word to a NOT-connection.

10. The method according to claim 1, further comprising a step of displaying the search words in the search word field in a logical expression form when search word nodes and connectors are displayed in the search expression field.

11. The method according to claim 10, further comprising a step of applying, in response to a change in the logical expression in the search word field, the change to the search expression in the search expression field.

12. An apparatus for supporting creation of a search expression that employs a plurality of words, comprising:
a display unit configured to display a search expression creation support screen comprising a search word field for inputting therein search words and a search expression field for visually displaying, in a nodal form, a search expression that includes the inputted search words;
a categorization unit configured to sort the search words, inputted in the search word field, into one or more groups depending on their categories; and
a search expression creation unit configured to display, in the search expression field, the search words included in each of the groups as OR-connected nodes, and display connections between the groups as AND-connections,
wherein the search expression creation unit changes a search expression in the search expression field in response to a user's operation that has been performed in the search word field or in the search expression field.

13. The apparatus according to claim 12, wherein the search expression creation unit is further configured to display each of the OR-connections and the AND-connections as intemodal connectors.

14. The apparatus according to claim 13, wherein the search expression creation unit is further configured to display a change in a search expression in the search expression field in response to a user's operation on a connector in the search expression field.

15. The apparatus according to claim 14, wherein the search expression creation unit is further configured to display the cancellation of an existing connection relationship and display the establishment a new connection relationship in response to the operation by which the connector has been moved in the search expression field.

16. The apparatus according claim 1, wherein the search expression creation unit is further configured to display a number of extracted frequent words in a different field on the search expression creation support screen.

17. The apparatus according to claim 16, wherein the search expression creation unit is further configured to display OR-connections between a specific frequent word and a node of the existing group when the specific frequent word is included in the existing group, and AND-connections between the specific frequent word and the existing group when the specific frequent word is not included in the existing group in response to a drag-and drop operation wherein the specific frequent word displayed in the different field has been dragged-and-dropped in the search expression field.

18. The apparatus according to claim 16, wherein the search expression creation unit is further configured to display AND-connections between a specific frequent word and a specific search word node in response to a user's operation by which the specific frequent word displayed in the different field has been dragged-and-dropped to the specific search word node in the search expression field

19. The apparatus according to claim 12, wherein the search expression creation unit is further configured to display an exclusion button in connection with a number of individual search word nodes displayed in the search expression field, and display a NOT-connection of a corresponding search word in response to pressing of the exclusion button of a specific search word node.

20. The apparatus according to claim 12, wherein the search expression creation unit is further configured to display search words in the search word field in a logical expression form when search word nodes and connectors are displayed in the search expression field.

21. The apparatus according to claim 20, wherein the search expression creation unit is further configured to display a change to the search expression in the search expression field in response to a change in the logical expression in the search word field.

22. The apparatus according to claim 12, wherein the display unit further comprising a vertical scroll bar configured to appear when a predetermined number of OR-connected nodes are included in the search expression field, wherein the vertical scroll bar is configured to provide for vertical scrolling through the OR-connected nodes.

23. The apparatus according to claim 12, wherein the display unit further comprising a horizontal scroll bar configured to appear when a predetermined number of AND-connected groups are included in the search expression field, wherein the horizontal scroll bar is configured to provide for horizontal scrolling through the AND-connected groups.

24. A computer program product for supporting creation of a search expression that employs a plurality of words, the computer program product comprising:
a computer usable medium having computer usable program code embodied therewith, the computer usable program code comprising:
computer usable program code configured to display a search expression creation support screen comprising a search word field for inputting therein search words and a search expression field for visually displaying, in a nodal form, a search expression that includes the inputted search words;
computer usable program code configured to sort the search words, inputted in the search word field, into one or more groups depending on their categories;
computer usable program code configured to display, in the search expression field, the search words included in each of the groups as OR-connected nodes, while displaying connections between the groups as AND-connections; and
computer usable program code configured to change a search expression in the search expression field in response to a user's operation that has been performed in the search word field or in the search expression field.

25. The computer program product according to claim 24, further comprising:
computer usable program code configured to extract frequent words from the search results; and
computer usable program code configured to display the extracted frequent words in a different field on the search expression creation support screen.
